(19) United States
(12) Patent Application Publication
(10) Pub. No.: US 2009/0164304 A1
(43) Pub. Date: Jun. 25, 2009

(54) Method and system for using a self learning algorithm to manage a progressive discount

(75) Inventors: Jonathan Otto, Palm Beach, FL (US); Andrew Van Luchene, Santa Fe, NM (US); Raymond J. Mueller, Palm Beach Gardens, FL (US); Michael R. Mueller, San Francisco, CA (US)

Correspondence Address: SIMPSON & SIMPSON, PLLC, 5555 MAIN STREET, WILLIAMSVILLE, NY, 14221-5406, US

(73) Assignee: RetailDNA, LLC, Lake Worth, FL (US)

(21) Appl. No.: 12/231,817

(22) Filed: Sep. 5, 2008

Related U.S. Application Data
(63) Continuation-in-part of application No. 12/151,043, filed on May 2, 2008.
Application No. 12/151,043 is a continuation-in-part of application No. 11/983,679, filed on Nov. 9, 2007.
Application No. 11/983,679 is a continuation-in-part of application No. 09/993,228, filed on Nov. 14, 2001.

(51) Int. Cl. G06Q 10/00; G06Q 30/00; G06N 5/00

(52) U.S. Cl. 705/10; 705/14; 706/45; 706/47

(57) ABSTRACT

A system for managing a progressive incentive, including: an interface element for at least one specially programmed general-purpose computer for receiving data regarding a current transaction between a customer and a business entity; and a memory unit for the specially programmed general-purpose computer for storing at least one compliance parameter and an artificial intelligence program (AIP). The system also includes a processor for the specially programmed general-purpose computer for: determining, using the data, compliance of the current transaction with at least one compliance parameter; for compliance of the current transaction with the at least one compliance parameter, augmenting, using the AIP, an incentive included in an offer previously presented to the customer, the augmented incentive to optimize revenue for the business entity or profitability of the business entity; generating a second offer including the augmented incentive; and transmitting, using the interface element, the second offer for presentation to the customer.

### CROSS-REFERENCE TO RELATED APPLICATIONS

This is a continuation-in-part patent application under 35 USC 120 of U.S. patent application Ser. No. 12/151,043, filed May 2, 2008 and entitled “Method and System For Centralized Generation of a Business Executable Using Genetic Algorithms and Rules Distributed Among Multiple Hardware Devices,” which is a continuation-in-part of U.S. patent application Ser. No. 11/983,679, filed Nov. 9, 2007 and entitled “Method and System for Generating, Selecting, and Running Executables in a Business System Utilizing a Combination of User Defined Rules and Artificial Intelligence” which is a continuation-in-part patent application under 35 USC 120 of U.S. patent application Ser. No. 09/993,228, filed Nov. 14, 2001 and entitled “Method and apparatus for dynamic rule and/or offer generation,” which applications are incorporated herein by reference.

This application is related to: U.S. patent application Ser. No. 09/052,093 entitled “Vending Machine Evaluation Network” and filed Mar. 31, 1998; U.S. patent application Ser. No. 09/083,483 entitled “Method and Apparatus for Selling an Aging Food Product” and filed May 22, 1998; U.S. patent application Ser. No. 09/282,747 entitled “Method and Apparatus for Providing Cross-Benefits Based on a Customer Activity” and filed Mar. 31, 1999; U.S. patent application Ser. No. 08/943,483 entitled “System and Method for Facilitating Acceptance of Conditional Purchase Offers (CPOs)” and filed on Oct. 3, 1997, which is a continuation-in-part of U.S. patent application Ser. No. 08/923,683 entitled “Conditional Purchase Offer (CPO) Management System For Packages” and filed Sep. 4, 1997, which is a continuation-in-part of U.S. patent application Ser. No. 08/889,319 entitled “Conditional Purchase Offer Management System” and filed Jul. 8, 1997, which is a continuation-in-part of U.S. patent application Ser. No. 08/707,660 entitled “Method and Apparatus for a Cryptographically Assisted Commercial Network System Designed to Facilitate Buyer-Driven Conditional Purchase Offers,” filed on Sep. 4, 1996 and issued as U.S. Pat. No. 5,794,207 on Aug. 11, 1998; U.S. patent application Ser. No. 08/920,116 entitled “Method and System for Processing Supplementary Product Sales at a Point-Of-Sale Terminal” and filed Aug. 26, 1997, which is a continuation-in-part of U.S. patent application Ser. No. 08/822,709 entitled “System and Method for Performing Lottery Ticket Transactions Utilizing Point-Of-Sale Terminals” and filed Mar. 21, 1997; U.S. patent application Ser. No. 09/135,179 entitled “Method and Apparatus for Determining Whether a Verbal Message Was Spoken During a Transaction at a Point-Of-Sale Terminal” and filed Aug. 17, 1998; U.S. patent application Ser. No. 09/538,751 entitled “Dynamic Propagation of Promotional Information in a Network of Point-of-Sale Terminals” and filed Mar. 30, 2000; U.S. patent application Ser. No. 09/442,754 entitled “Method and System for Processing Supplementary Product Sales at a Point-of-Sale Terminal” and filed Nov. 12, 1999; U.S. patent application Ser. No. 09/045,386 entitled “Method and Apparatus For Controlling the Performance of a Supplementary Process at a Point-of-Sale Terminal” and filed Mar. 20, 1998; U.S. patent application Ser. No. 09/045,347 entitled “Method and Apparatus for Providing a Supplementary Product Sale at a Point-of-Sale Terminal” and filed Mar. 20, 1998; U.S. patent application Ser. No. 09/083,689 entitled “Method and System for Selling Supplementary Products at a Point-of Sale and filed May 21, 1998; U.S. patent application Ser. No. 09/045,518 entitled “Method and Apparatus for Processing a Supplementary Product Sale at a Point-of-Sale Terminal” and filed Mar. 20, 1998; U.S. patent application Ser. No. 09/076,409 entitled “Method and Apparatus for Generating a Coupon” and filed May 12, 1998; U.S. patent application Ser. No. 09/045,084 entitled “Method and Apparatus for Controlling Offers that are Provided at a Point-of-Sale Terminal” and filed Mar. 20, 1998; U.S. patent application Ser. No. 09/098,240 entitled “System and Method for Applying and Tracking a Conditional Value Coupon for a Retail Establishment” and filed Jun. 16, 1998; U.S. patent application Ser. No. 09/157,837 entitled “Method and Apparatus for Selling an Aging Food Product as a Substitute for an Ordered Product” and filed Sep. 21, 1998, which is a continuation of U.S. patent application Ser. No. 09/083,483 entitled “Method and Apparatus for Selling an Aging Food Product” and filed May 22, 1998; U.S. patent application Ser. No. 09/603,677 entitled “Method and Apparatus for selecting a Supplemental Product to offer for Sale During a Transaction” and filed Jun. 26, 2000; U.S. Pat. No. 6,119,100 entitled “Method and Apparatus for Managing the Sale of Aging Products and filed Oct. 6, 1997 and U.S. Provisional Patent Application Ser. No. 60/239,610 entitled “Methods and Apparatus for Performing Upsells” and filed Oct. 11, 2000.

By “related to” we mean that the present application and the applications noted above are in the same general technological area and have a common inventor or assignee. However, “related to” does not necessarily mean that the present application and any or all of the applications noted above are patentably indistinct, or that the filing date for the present application is within two months of any of the respective filing dates for the applications noted above.

### FIELD OF THE INVENTION

The invention relates generally to a method and system for managing a progressive discount, or incentive and, more particularly, to methods and systems for providing such management using artificial intelligence.

### BACKGROUND OF THE INVENTION

The management of progressive discount programs is known, for example, as disclosed in U.S. Published Patent Applications 2007/0130016 (Walker et al.) and 2007/0124209 (Walker et al.), incorporated by reference herein. Unfortunately, such programs do not automatically generate or modify aspects of the programs.

Thus, there is a long-felt need to provide a system and a method to manage a progressive discount that is dynamic and can be readily adapted to meet various and variable requirements.

### SUMMARY OF THE INVENTION

The invention broadly comprises a system for managing a progressive incentive, including: an interface element for at least one specially programmed general-purpose computer for receiving data regarding a current transaction between a customer and a first business entity; and a memory unit for the at least one specially programmed general-purpose computer for storing at least one compliance parameter and an artificial intelligence program (AIP). The system also includes a processor for the at least one specially programmed general-purpose computer for: determining, using the data, compliance of the current transaction with at least one compliance parameter; for compliance of the current transaction with the at least one compliance parameter, augmenting, using the AIP, an incentive included in a first offer previously presented to the customer, the augmented incentive to optimize revenue for the first business entity or profitability of the first business entity; generating a second offer including the augmented incentive; and transmitting, using the interface element, the second offer for presentation to the customer.

In one embodiment, determining compliance of the current transaction with the at least one compliance parameter includes using the AIP, or the second offer includes a good or service offered by the first business entity and the processor is for selecting the good or service using the AIP. In another embodiment, the memory element is for storing a history of transactions between the customer and the first business entity, the history including a plurality of offers included in previous transactions between the customer and the first business entity; and, the processor is for: determining optimization of revenue or profitability for the first business entity resulting from the plurality of offers included in the previous transactions between the customer and the first business entity; and augmenting the incentive according to the determination of optimization of revenue or profitability; or generating the second offer according to the determination of optimization of revenue or profitability. In a further embodiment, the processor is for determining optimization of revenue or profitability for the first business entity using the AIP.

In one embodiment, the memory element is for storing at least one metric; and the processor is for: comparing the data regarding the current transaction to the at least one metric stored in the memory element; determining, using the comparison of the data regarding the current transaction to the at least one metric, a classification of the customer; and augmenting the incentive included in a first offer using the classification of the customer; or, generating the second offer using the classification of the customer. In another embodiment, the processor is for determining the classification using the AIP.

In one embodiment, the processor is for generating or modifying, using the AIP, a format or temporal parameter for a presentation of the second offer and transmitting the second offer for presentation to the customer includes transmitting the format or temporal parameter. In another embodiment, the memory element is for storing a history of transactions between the customer and the first business entity in the memory element, the history including a plurality of offers included in previous transactions between the customer and the first business entity; and, the processor is for adding the second offer to the history of transactions.

In one embodiment, the memory element is for storing a history of transactions between the customer and the first business entity in the memory element, the history including a plurality of offers included in previous transactions between the customer and the first business entity; and the processor is for: determining optimization of revenue or profitability for the first business entity resulting from the plurality of offers included in the previous transactions between the customer and the first business entity; and generating, using the determination of optimization, the first offer. In another embodiment, determining optimization includes using the AIP or wherein generating the first offer includes using the AIP.

In one embodiment, the processor is for: receiving, using the interface element, at least one rule from a wireless communications device (WCD) or from a general-purpose computer associated with a second business entity; and storing the at least one rule in the memory element; receiving the data regarding a current transaction according to the at least one rule; determining the compliance of the current transaction with the at least one compliance parameter according to the at least one rule; augmenting the incentive included in the first offer according to the at least one rule; or generating the second offer according to the at least one rule.

In one embodiment, a WCD with a processor and a memory element is usable to present the offer to the customer, the memory element for the WCD is for storing at least one rule in a memory element for the WCD, and the processor for the WCD is for executing the second offer according to the at least one rule.

The invention broadly comprises a system for managing a progressive incentive, including: an interface element for at least one specially programmed general-purpose computer for receiving, using an interface element for the at least one specially-programmed general purpose computer, data regarding a current transaction between the customer and the first business entity; and a memory unit for the at least one specially programmed general-purpose computer for storing a history of transactions between a customer and a first business entity and for storing and an artificial intelligence program (AIP), the history including a plurality of offers included in previous transactions between the customer and the first business entity. The system also includes a processor for the at least one specially programmed general-purpose computer for: determining optimization of revenue or profitability for the first business entity resulting from the plurality of offers included in the previous transactions between the customer and the first business entity; modifying, using the AIP, an incentive included in a first offer previously presented to the customer, according to the determination of optimization of revenue or profitability; generating a second offer including the modified incentive; and transmitting, using the interface element, the second offer for presentation to the customer.

In one embodiment, the processor is for: generating the second offer according to the determination of optimization of revenue or profitability; determining optimization using the AIP; or generating the second offer using the AIP. The second offer includes a good or service offered by the first business entity and the processor is for selecting the good or service using the AIP. In another embodiment, the memory element is for storing at least one compliance parameter; and the processor is for determining, using the data, compliance of the current transaction with at least one compliance parameter, and for compliance of the current transaction with the at least one compliance parameter, modifying the incentive includes augmenting the incentive. In a further embodiment, determining compliance of the current transaction with the at least one compliance parameter includes using the AIP.

In one embodiment, the memory element is for storing at least one metric in the memory element; and the processor is for: comparing the data regarding the current transaction to the at least one metric stored in the memory element; and determining, using the comparison of the data regarding the current transaction to the at least one metric, a classification of the customer. The incentive included in a first offer includes using the classification of the customer, or generating the second offer includes using the classification of the customer. In another embodiment, the processor is for adding the second offer to the history of transactions. In a further embodiment, the processor is for generating, using the determination of optimization, the first offer.

In one embodiment, the processor is for generating or modifying, using the AIP, a format or temporal parameter for a presentation for the second offer, and transmitting the second offer for presentation to the customer includes transmitting the format or temporal parameter. In another embodiment, the processor is for: receiving, using the interface element, at least one rule from a wireless communications device (WCD) or from a general-purpose computer associated with a second business entity; storing the at least one rule in the memory element; and receiving the data regarding a current transaction includes receiving according to the at least one rule; determining the optimization includes determining according to the at least one rule; modifying the incentive included in the first offer includes modifying according to the at least one rule; or generating the second offer includes generating according to the at least one rule.

In one embodiment, a WCD with a processor and a memory element is usable to present the offer to the customer, the memory element for the WCD is for storing at least one rule in a memory element for the WCD, and the processor for the WCD is for executing the second offer according to the at least one rule.

The invention also broadly comprises a method for managing a progressive incentive.

It is a general object of the present invention to provide a system and a method to automatically and intelligently generate, modify, or present a progressive incentive.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing Figures, in which:

FIG. 1 is a schematic block diagram of a present invention system for managing a progressive incentive;

FIG. 2 is a flow chart of a present invention method for managing a progressive incentive; and,

FIG. 3 is a flow chart of a present invention method for managing a progressive incentive.

### DETAILED DESCRIPTION OF THE PREFERRED EMBODIMENT

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein shall include the same meaning as commonly understood to one of ordinary skill in the art to which this invention belongs. Although any methods, devices or materials similar or equivalent to those described herein can be used in the practice or testing of the invention, the preferred methods, devices, and materials are now described.

It should be understood that the use of “or” in the present application is with respect to a “non-exclusive” arrangement, unless stated otherwise. For example, when saying that “item x is A or B,” it is understood that this can mean one of the following: 1) item x is only one or the other of A and B; and 2) item x is both A and B. Alternately stated, the word “or” is not used to define an “exclusive or” arrangement. For example, an “exclusive or” arrangement for the statement “item x is A or B” would require that x can be only one of A and B.

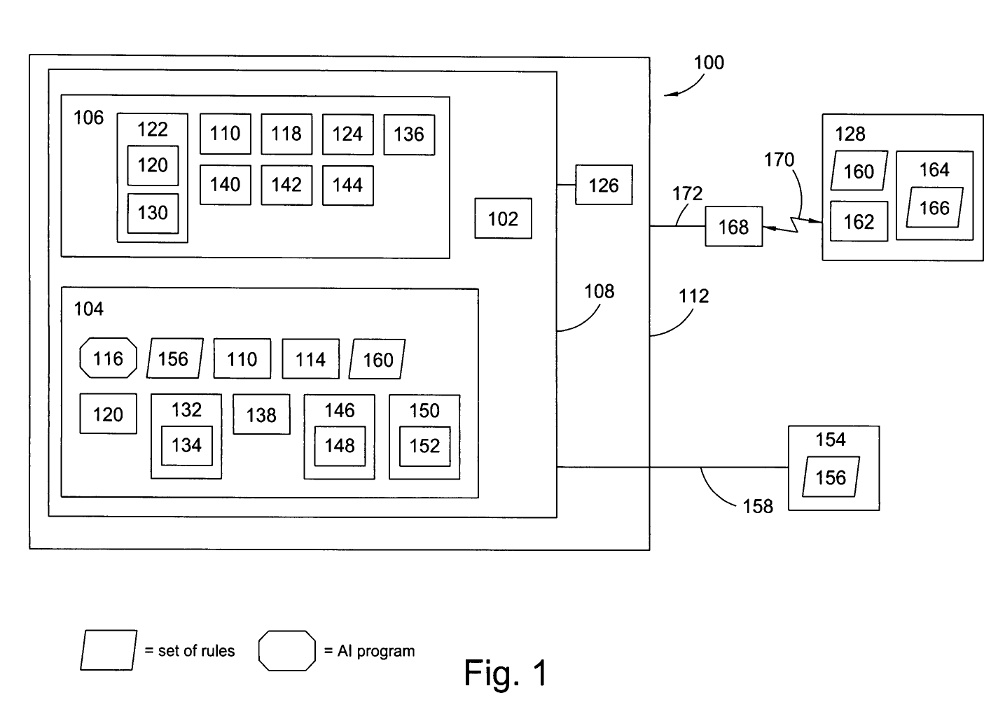

FIG. 1 is a schematic block diagram of present invention system 100 for managing a progressive incentive. The system includes interface element 102, memory element 104, and processor 106 for at least one specially programmed general-purpose computer 108. The interface element is for receiving data 110 regarding a current transaction between a customer (not shown) and a first business entity, for example, a business entity associated with location 112. The memory unit stores at least one compliance parameter 114 and at least one artificial intelligence program (AIP) 116. The transaction can be any transaction known in the art. In one embodiment, the transaction is a retail transaction. That is, the customer is purchasing a good or item from the first business entity.

The processor determines, using data 110, compliance determination 118. That is, the processor determines if the current transaction is in compliance with the compliance parameter. If the transaction is found to be in compliance with the compliance parameter, the processor augments, using the AIP, incentive 120 included in offer 122 previously presented to the customer. The incentive is augmented to optimize revenue for the first business entity or profitability of the first business entity. The processor generates offer 122 including the augmented incentive and transmits, using the interface element, offer 122 for presentation to the customer. Offer 122 can be presented using any means known in the art.

In one embodiment, the offer is transmitted for presentation on any point of sale (POS) station known in the art, for example, POS station 126 in location 112. In another embodiment, the offer is transmitted for presentation on any device, remote from a location associated with the first business entity, such as location 114, known in the art, for example, a remote kiosk (not shown) or wireless communications device (WCD) 128. WCD 128 can be any WCD known in the art. Commonly-owned and co-pending U.S. patent application Ser. No. 12/151,040, entitled “METHOD AND SYSTEM FOR MANAGING TRANSACTIONS INITIATED VIA A WIRELESS COMMUNICATIONS DEVICE”, filed May 2, 2008 is applicable to interaction of the WCD and system 100.

By interface element, we mean any combination of hardware, firmware, or software in a computer used to enable communication or data transfer between the computer and a device, system, or network external to the computer. The interface element can connect with the device, system, or network external to the computer using any means known in the art, including, but not limited to a hardwire connection, an optical connection, an Internet connection, or a radio frequency connection. Processor 106 and interface element 102 can be any processor or interface element, respectively, or combination thereof, known in the art.

Computer 108 can be any computer or plurality of computers known in the art. In one embodiment, the computer is located in a retail location with which system 100 is associated, for example, location 112. In another embodiment (not shown), all or parts of the computer are remote from retail locations with which system 100 is associated. In a further embodiment, computer 108 is associated with a plurality of retail locations with which system 100 is associated. Thus, the computer provides the functionality described for more than one retail location.

Incentive 120 can be any incentive known in the art, for example, including, but not limited to a discount on an item or service or a free item or service. By current transaction, we mean that the transaction is in progress. For example, an order has been placed by the customer at a restaurant or retail establishment. Any transaction involving a customer and a business entity is included in the spirit and scope of the claimed invention. In one embodiment, the compliance parameter is with respect to a program for progressive incentives, for example, discounts, offered to a customer if the transactions involving the customer comply with one or more requirements, for example, compliance parameter 114. The compliance parameter can be any parameter known in the art. As non-limiting examples, the compliance parameter could include a maximum time between transactions involving the customer and the first business entity; a minimum amount for an order; or specified items included in an order. Thus, determination 118 indicates if the transaction meets the requirements of the program for progressive incentives.

In one embodiment, the processor uses the AIP to determine compliance of the current transaction with the at least one compliance parameter. In another embodiment, offer 122 includes good or service 130 offered by the first business entity. Good or service 130 can be any good or service known in the art. The processor selects the good or service using the AIP. In a further embodiment, the processor uses the AIP to generate offer 122. The following U.S. patent applications are applicable to the use of the AIP to generate an offer: U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007; commonly-owned U.S. patent application Ser. No. 12/151/043, titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed May 2, 2008; commonly-owned U.S. patent application Ser. No. 12/151,038, titled: “METHOD AND APPARATUS FOR GENERATING AND TRANSMITTING AN ORDER INITIATION OFFER TO A WIRELESS COMMUNICATIONS DEVICE,” inventors Otto et al., filed May 2, 2008; commonly-owned U.S. patent application Ser. No. 12/151,040, entitled “METHOD AND SYSTEM FOR MANAGING TRANSACTIONS INITIATED VIA A WIRELESS COMMUNICATIONS DEVICE”, filed May 2, 2008; commonly-owned U.S. patent application Ser. No. 12/151,042, entitled “METHOD AND SYSTEM FOR GENERATING AN OFFER AND TRANSMITTING THE OFFER TO A WIRELESS COMMUNICATIONS DEVICE”, filed May 2, 2008; commonly-owned U.S. patent application Ser. No. 12/151,042, entitled “METHOD AND SYSTEM FOR GENERATING AN OFFER AND TRANSMITTING THE OFFER TO A WIRELESS COMMUNICATIONS DEVICE”, filed May 2, 2008; commonly-owned U.S. patent application entitled “SYSTEM AND METHOD FOR PROVIDING INCENTIVES TO AN END USER FOR REFERRING ANOTHER END USER”, inventors Otto et al., filed Jul. 9, 2008; commonly-owned U.S. patent application entitled “METHOD AND SYSTEM FOR GENERATING A REAL TIME OFFER OR A DEFERRED OFFER”, inventors Otto et al., filed Jul. 9, 2008; commonly-owned U.S. patent application entitled “METHOD AND APPARATUS FOR GENERATING AND TRANSMITTING AN IDEAL ORDER OFFER”, inventors Otto et al., filed Jul. 9, 2008; commonly-owned U.S. patent application entitled “SYSTEM AND METHOD FOR GENERATING AND TRANSMITTING LOCATION BASED PROMOTIONAL OFFER REMINDERS”, inventors Otto et al., filed Jul. 9, 2008; commonly-owned U.S. patent application entitled “SYSTEM AND METHOD FOR LOCATION BASED SUGGESTIVE SELLING”, filed Jul. 9, 2008; and commonly-owned U.S. patent application entitled “SYSTEM AND METHOD FOR SCANNING A COUPON TO INITIATE AN ORDER”, filed May 2, 2008.

In one embodiment, the memory element is for storing history 132 of transactions between the customer and the first business entity. The history includes plurality 134 of offers included in previous transactions between the customer and the first business entity. The processor determines optimization 136 of revenue or profitability for the first business entity resulting from the plurality of offers included in the previous transactions between the customer and the first business entity. That is, the processor determines the success of the transactions in history 132 in attaining the optimization of revenue or profitability. Any measure or metric known in the art can be used with respect to the revenue or profitability, including, but not limited to optimizing or maximizing revenues, profits, item counts, average check, market basket contents, marketing offer acceptance, store visitation or other frequency measures, or improving or optimizing speed of service, inventory levels, turns, yield, waste, or enhancing or optimizing customer loyalty or use of kiosks or internet or other POS devices, or use of off peak or other coupons or acceptance of upsell or other marketing offers, or reduction or optimization of any customer or employee or any other person's gaming, fishing, or any other undesirable action or activities and/or failures to act when desired, or minimizing or optimizing any dilution or diversion of sales, profits, average check, or minimizing or optimizing use of discounts and other promotions so as to maximize or optimize any of the foregoing desired actions, outcomes or other desired benefits, or any combination of minimizing undesired results while maximizing or optimizing any one or more of any desired results. In another embodiment, the processor augments incentive 120 according to the determination of optimization of revenue or profitability. By augment, we mean that the incentive is made more valuable, or is otherwise made more attractive to the customer. Thus, as a result of the current transaction complying with the compliance parameter, a progressively more valuable or attractive incentive is presented to the customer. In a further embodiment, the processor generates offer 122 according to the determination of optimization of revenue or profitability. In yet another embodiment, the processor determines the optimization of revenue or profitability using the AIP.

In one embodiment, the memory element stores at least one metric 138 and the processor is for: comparing data 110 to the at least one metric stored to generate comparison 140; and determining, using comparison 140, classification 142 of the customer. In another embodiment, the processor augments incentive 120 using the classification of the customer. In a further embodiment, the processor generates offer 122 using the classification of the customer, for example, good or service 130 is selected according to the classification. Metric 138 can be any metric known in the art and the metric can be part of any classification system known in the art in order to result in classification 142. For example, in one embodiment, the intent of classification 142 is to place the customer is a hierarchy of candidacy for incentives. For example, the more favorable the comparison, the higher the customer's position in the hierarchy and the more valuable or attractive the incentives potentially available to the customer. Thus, incentive 120 can be made more or less valuable or attractive according to the classification, and offer, 122, for example, good or service 130, can be made more or less valuable or attractive according to the classification. In a further embodiment, the processor is for determining the classification using the AIP.

In one embodiment, the processor is for generating or modifying format or temporal parameter 144 for presentation of offer 122. For example, the parameter is with respect to a time of day, week, month, or year at which an offer is present, or with respect to a frequency with which an offer is presented. The processor transmits the format or temporal parameter along with offer 122 for presentation. In another embodiment, the processor used the AIP to generate or modify parameter 144.

In one embodiment, the memory element stores history 146 of transactions between the customer and the first business entity. The history includes plurality 148 of offers included in previous transactions between the customer and the first business entity. The processor adds offer 122 to history 146. That is, the processor updates the history to include offer 122.

In one embodiment, the memory element is for storing history 150 of transactions between the customer and the first business entity. The history includes plurality 152 of offers included in previous transactions between the customer and the first business entity. The processor determines optimization 154 of revenue or profitability for the first business entity resulting from plurality 152. That is, optimization 154 is an indication of how successful the plurality of offers was in optimizing revenue or profitability. In another embodiment, the processor generates offer 122 using determination 154. For example, offers that have resulted in greater optimization can be offered more frequently than offers that have resulted in lesser optimization. In a further embodiment, the processor uses the AIP to determine optimization. In yet another embodiment, the processor uses the AIP and optimization 154 to generate offer 122.

Thus, the processor determines the success of the transactions in history 150 in attaining the optimization of revenue or profitability. Any measure or metric known in the art can be used with respect to the revenue or profitability, including, but not limited to optimizing or maximizing revenues, profits, item counts, average check, market basket contents, marketing offer acceptance, store visitation or other frequency measures, or improving or optimizing speed of service, inventory levels, turns, yield, waste, or enhancing or optimizing customer loyalty or use of kiosks or internet or other POS devices, or use of off peak or other coupons or acceptance of upsell or other marketing offers, or reduction or optimization of any customer or employee or any other person's gaming, fishing, or any other undesirable action or activities and/or failures to act when desired, or minimizing or optimizing any dilution or diversion of sales, profits, average check, or minimizing or optimizing use of discounts and other promotions so as to maximize or optimize any of the foregoing desired actions, outcomes or other desired benefits, or any combination of minimizing undesired results while maximizing or optimizing any one or more of any desired results. Thus, offer 122, for example, incentive 120, or good or service 130, is made more or less valuable or attractive depending on the success of the transaction in history 150 with respect to optimizing revenue or profitability. For example, for a good or service that has a good history of optimizing revenue or profitability, the incentive could be increased to encourage the customer to select the good or service.

In one embodiment, computer 154, separate from computer 108, transmits modifying rule 156 to computer 108. Computer 154 can be in location 112 (not shown) or can be in a different location. Computer 154 can be associated with a business entity associated with location 112 or can be associated with a different business entity. Connection 158 between computers 108 and 154 can be any type known in the art. In another embodiment (not shown), multiple computers 154 are included and respective computers among the multiple computers can be associated with the same or different business entities. Computer 108 stores modifying rule 156 in memory 104. The rule affects the function of computer 108. For example, the interface element receives data 110 according rule 156; or the processor: determines the compliance of the current transaction with the compliance parameter according rule 156; augments incentive 120 according rule 156; or, generates offer 122 according rule 156. Commonly owned U.S. patent application Ser. No. 12/151,043, filed May 2, 2008 and entitled “Method and System For Centralized Generation of a Business Executable Using Genetic Algorithms and Rules Distributed Among Multiple Hardware Devices” is applicable to the respective operations of the interface element and the processor with respect to rule 156.

In one embodiment, computer 108 receives at least one modifying rule 160 from a WCD associated with the customer, for example, WCD 128 and stores the rule in memory 104. The rule affects the function of computer 108. For example, the interface element receives data 110 according rule 160; or the processor: determines the compliance of the current transaction with the compliance parameter according rule 160; augments incentive 120 according rule 160; or, generates offer 122 according rule 160. Commonly owned U.S. patent application Ser. No. 12/151,043, filed May 2, 2008 and entitled “Method and System For Centralized Generation of a Business Executable Using Genetic Algorithms and Rules Distributed Among Multiple Hardware Devices” is applicable to the respective operations of the interface element and the processor with respect to rule 160.

In one embodiment, a WCD, for example, WCD 128, with a processor and a memory element, for example, processor 162 and memory 164, is usable to present the offer to the customer. The memory element for the WCD stores at least one rule, for example, rule 166 and the processor for the WCD executes offer 122 according to the rule, for example, rule 166. Commonly-owned and co-pending U.S. patent application Ser. No. 12/151,040, entitled “METHOD AND SYSTEM FOR MANAGING TRANSACTIONS INITIATED VIA A WIRELESS COMMUNICATIONS DEVICE”, filed May 2, 2008 is applicable to the operations described regarding WCD 128, processor 162, rule 166, and order 122.

In one embodiment, a WCD usable with system 100, for example, WCD 128, is owned by, leased by, or otherwise already in possession of an end user when system 100 interfaces with the WCD. In the description that follows, it is assumed that the WCD is owned by, leased by, or otherwise already in possession of the end user when system 100 interfaces with the WCD. In general, the WCD communicates with a network, for example, network 168, via radio-frequency connection 170. Network 168 can be any network known in the art. In one embodiment, the network is located outside of the retail location, for example, the network is a commercial cellular telephone network. In one embodiment (not shown), the network is located in a retail location, for example, the network is a local network, such as a Bluetooth network. The interface element can connect with network 168 using any means known in the art, including, but not limited to a hardwire connection, an optical connection, an Internet connection, or a radio frequency connection. In the figures, a non-limiting example of a hardwire connection 172 is shown. In one embodiment, device 128 is connectable to a docking station (not shown) to further enable communication between device 128 and system 100. Any docking station or docking means known in the art can be used. That is, when the device is connected to the docking station, a link is established between the device and system 100.

Commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007, is applicable to the operations involving the AIP, noted supra and infra.

In one embodiment, system 100 generates a customer rating/class, for example, classification 142, which is a score given to the customer by either a genetic algorithm, such as the AIP, by business entity personnel, or both. The rating or class is used to qualify a customer for various types and classes of offers. Thus, system 100 provides incentives, for example, discounts off of retail transactions, that increase over time as long as the customer follows the purchase rules of the system, for example, the current transaction complies with the compliance parameter. A self learning algorithm, for example, the AIP, adjusts the rules controlling receipt by each customer of incremental or “progressive” discounts to maximize revenue and profitability for the retailer or group of retailers using the system, for example, the augmenting of incentive 120 or the modifying of offer 122 described supra.

In one embodiment, system 100 analyzes the performance of a discount program offered to and accepted by a particular customer or class of customers. Adjustments are made to the program based on its success and transmitted or otherwise made available to the same customer or class of customers. If the program offers are accepted, the customer account is registered with the new incentive program and measured for later optimization.

System 100 can determine, modify, or manage the following:
1. Customer ratings by customer, for example, classification 142, that is, a score or rating given to each customer to determine the type of discount program for which the customer qualifies. The rating can be adjusted based on:
   a. the transaction total of one or more transactions
   b. temporal parameters, such as the time since the last transaction
   c. use of coupons
   d. purchase of discounted products only
   e. purchase of loss leaders
   f. any other metric to determine how profitable a customer is for a business entity operating or benefiting from system 100
2. Incentive increment, for example, the augmentation of incentive 120. That is, the incremental, additive incentive, for example, discount percent or fixed dollar amount, that is added to each subsequent purchase of the customer
3. Maximum discount. That is, the maximum incentive, for example, percent or fixed dollar discount, that can be applied to any transaction
4. Grace period. That is, temporal parameters governing compliance of the customer, for example, the amount of time in between transactions that still allows a customer to stay in the program
5. Transaction frequency requirement, for example, how often the customer needs to make transactions to stay in the program
6. Adjusting the incentive discount and determining when to apply the discount
7. Presentation, that is, how the incentive is output and conveyed to customer, for example, print a coupon or output email based on whether or not customer has a frequent shopper card
8. Rules governing incentives, for example, discounts, given to loyal customers
9. Rules defining a loyal customer
10. Price of incentive or discount
11. Time between transactions
12. Incentive or discount amount

The discussion in commonly-owned U.S. patent application Ser. No. 11/983,679, filed Nov. 9, 2006 and entitled “Method and System for Generating, Selecting, and Running Executables in a Business System Utilizing a Combination of User Defined Rules and Artificial Intelligence” is applicable to the modification of incentive 120 or offer 130 by the processor.

As disclosed in commonly-owned U.S. patent application titled: “METHOD AND APPARATUS FOR GENERATING AND TRANSMITTING AN IDEAL ORDER OFFER,” inventors Otto et. al, filed Jul. 9, 2008, which application is incorporated by reference herein, in one embodiment, the processor reviews information 132, 146 or 150 to identify an item or service not included in the history (an presumably never ordered by the customer) or ordered by the customer at less than a predetermined frequency. Then, the processor, using the AIP, optimizes pairings of upsells and incentives, for example, by including in an upsell an item or service not included in the information or ordered at less than a predetermined frequency. In another embodiment, this pairing is used to realize attainment of metric 138.

As disclosed in commonly-owned U.S. patent application titled: “METHOD AND APPARATUS FOR GENERATING AND TRANSMITTING AN IDEAL ORDER OFFER,” inventors Otto et. al, filed Jul. 9, 2008, in one embodiment, based upon the acceptance or rejection rates by a customer or customers of offers associated with upsells, the system determines the difficulty associated with accepting the upsell. If found to be difficult, e.g., due to a higher than average rejection rate, system 100 can increase, using the AIP, the incentive associated with the offers.

It should be understood that various storage and removal operations, not explicitly described above, involving memory 104 and as known in the art, are possible with respect to the operation of system 100. For example, outputs from and inputs to the general-purpose computer can be stored and retrieved from the memory elements and data generated by the processor can be stored in and retrieved from the memory.

It should be understood that system 100 can be operated by the same business entity operating or owning a business location using the system, or can be operated by a third party different than the business entity operating or owning the business location using the system. In one embodiment, a third party operates system 100 as disclosed by commonly-owned U.S. patent application Ser. No. 11/985,141: “UPSELL SYSTEM EMBEDDED IN A SYSTEM AND CONTROLLED BY A THIRD PARTY,” inventors Otto et al., filed Nov. 13, 2007.

It should be understood that system 100 can be integral with a computer operating system for a business location, for example, location 112 or with a business entity operating the business location. It also should be understood that system 100 can be wholly or partly separate from the computer operating system for a retail location, for example, location 112, or with a business entity operating the business location.

It should be understood that although individual rule sets and a single artificial intelligence program are discussed, the individual rule sets can be combined into a composite rules set (not shown). Further, the functions described for AIP 116 can be implemented by combinations of separate AIPs (not shown). Any combination of individual rule sets or artificial intelligence programs is included in the spirit and scope of the claimed invention.

In general, system 100, and in particular, the processor using the AI program, operates to use artificial intelligence, for example, a generic algorithm to inform or make some or all of the decisions discussed in the description for FIG. 1. In one embodiment, system 100 uses one or all of the historical data noted supra, to generate or modify incentive or offers, or perform the other operations described herein to attain or maximize an objective of the business entity, for example, performance with respect to metric 138. Factors usable to determine an objective can include, but are not limited to: customer acceptance rate, profit margin percentage, customer satisfaction information, service times, average check, inventory turnover, labor costs, sales data, gross margin percentage, sales per hour, cash over and short, inventory waste, historical customer buying habits, customer provided information, customer loyalty program data, weather data, store location data, store equipment package, POS system brand, hardware type and software version, employee data, sales mix data, market basket data, or trend data for at least one of these variables.

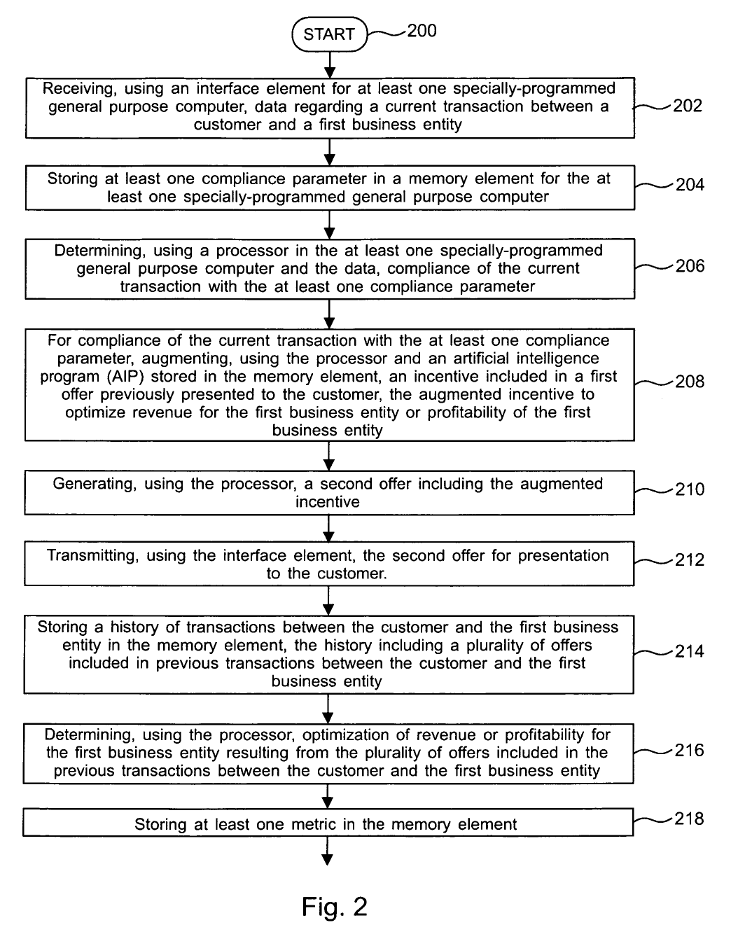

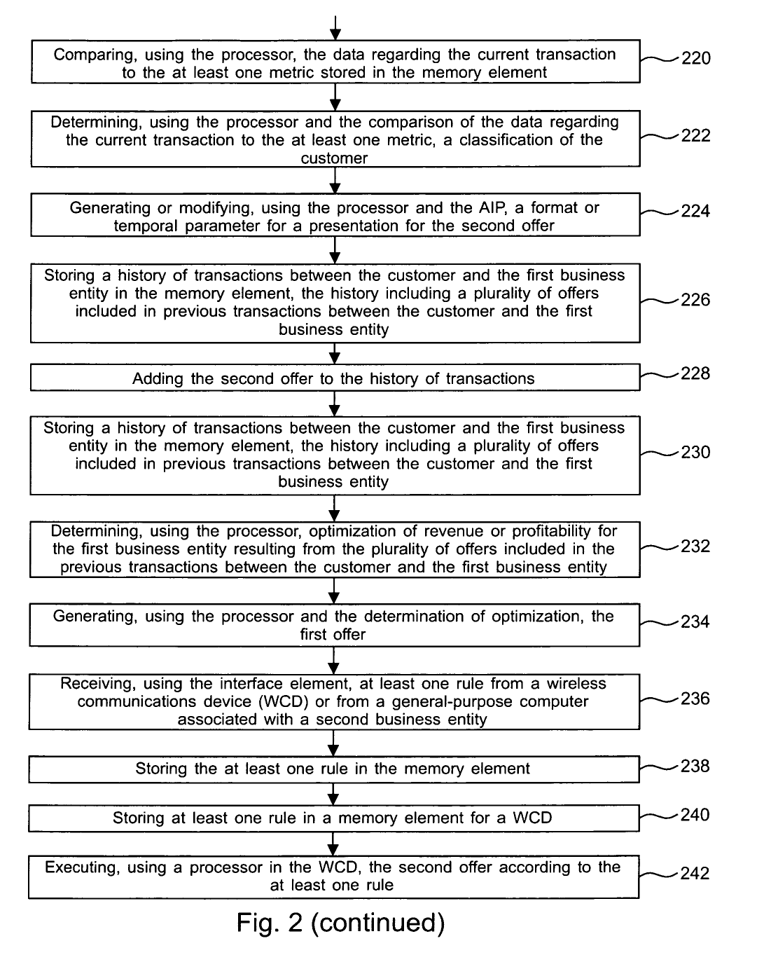

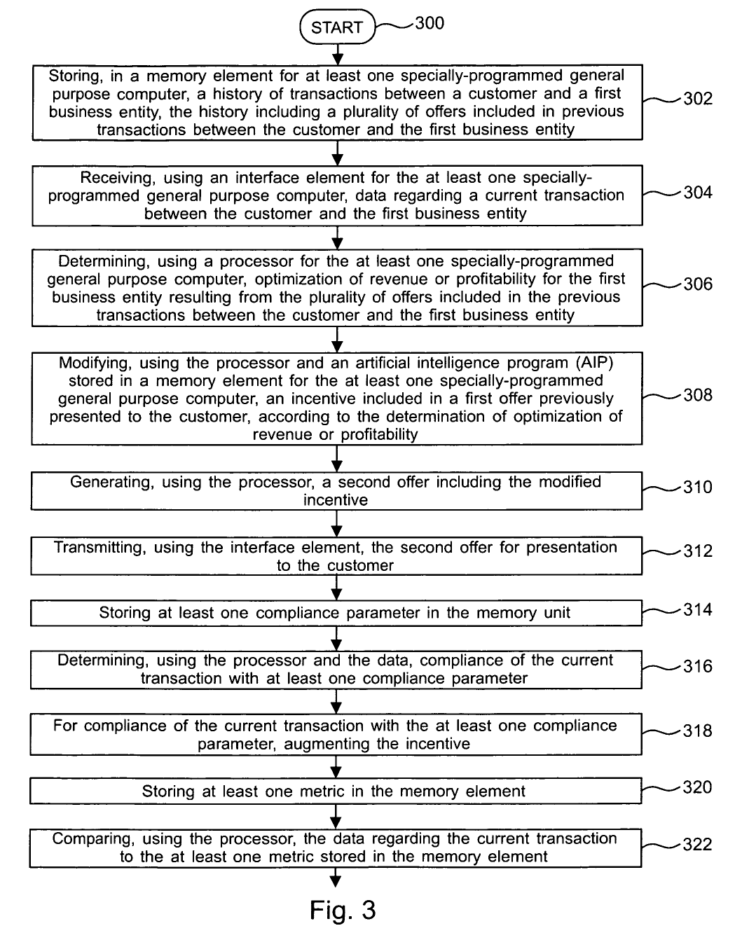

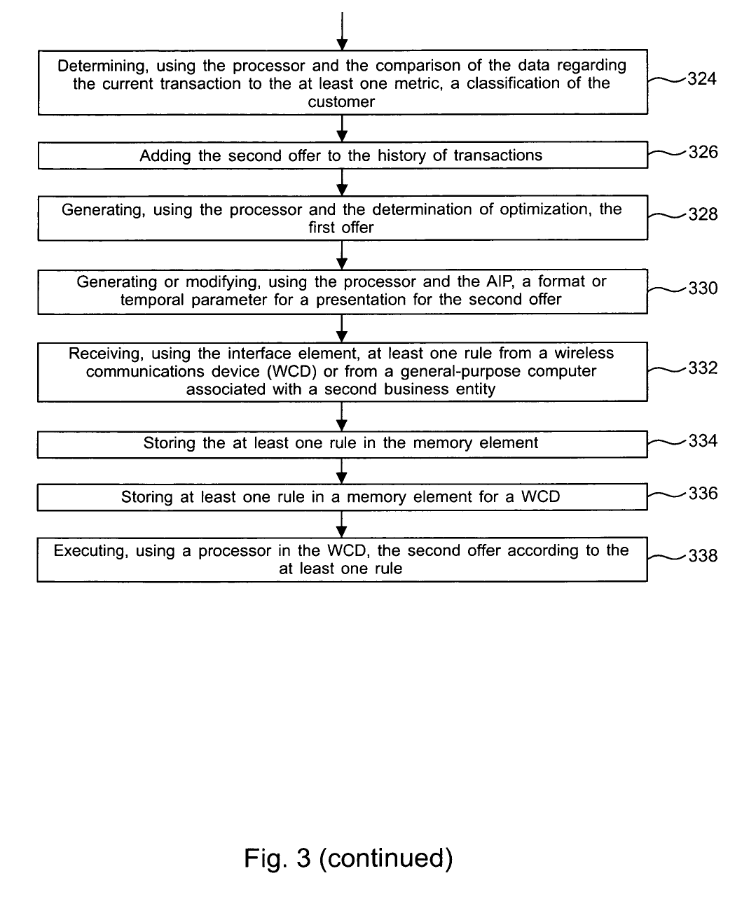

FIG. 2 is a flow chart illustrating a present invention computer-based method for managing a progressive incentive. Although the method in FIG. 2 (and FIG. 3 below) is depicted as a sequence of numbered steps for clarity, no order should be inferred from the numbering unless explicitly stated. The method starts at Step 200. Step 202 receives, using an interface element for at least one specially-programmed general purpose computer, data regarding a current transaction between a customer and a first business entity; step 204 stores at least one compliance parameter in a memory element for the at least one specially-programmed general purpose computer; step 206 determines, using a processor in the at least one specially-programmed general purpose computer and the data, compliance of the current transaction with at least one compliance parameter; for compliance of the current transaction with the at least one compliance parameter, step 208 augments, using the processor and an artificial intelligence program (AIP) stored in the memory element, an incentive included in a first offer previously presented to the customer, the augmented incentive to optimize revenue for the first business entity or profitability of the first business entity; step 210 generates, using the processor, a second offer including the augmented incentive; and step 212 transmits, using the interface element, the second offer for presentation to the customer.

In one embodiment, determining compliance of the current transaction with the at least one compliance parameter includes using the AIP, or the second offer includes a good or service offered by the first business entity and generating the second offer includes selecting the good or service using the processor and the AIP. In another embodiment, step 214 stores a history of transactions between the customer and the first business entity in the memory element, the history including a plurality of offers included in previous transactions between the customer and the first business entity; and step 216 determine, using the processor, optimization of revenue or profitability for the first business entity resulting from the plurality of offers included in the previous transactions between the customer and the first business entity. Augmenting the incentive included in the first offer includes augmenting the incentive according to the determination of optimization of revenue or profitability, or generating the second offer includes generating the second offer according to the determination of optimization of revenue or profitability. In another embodiment, determining optimization of revenue or profitability for the first business entity includes using the AIP.

In one embodiment, step 218 stores at least one metric in the memory element; step 220 compares, using the processor, the data regarding the current transaction to the at least one metric stored in the memory element; and step 222 determine, using the processor and the comparison of the data regarding the current transaction to the at least one metric, a classification of the customer. Augmenting the incentive included in a first offer includes using the classification of the customer, or generating the second offer includes using the classification of the customer. In another embodiment, determining a classification includes using the AIP. In a further embodiment, step 224, generates or modifies, using the processor and the AIP, a format or temporal parameter for a presentation for the second offer, and transmitting the second offer for presentation to the customer includes transmitting the format or temporal parameter.

In one embodiment, step 226 stores a history of transactions between the customer and the first business entity in the memory element, the history including a plurality of offers included in previous transactions between the customer and the first business entity; and step 228 adds the second offer to the history of transactions.

In one embodiment, step 230 stores a history of transactions between the customer and the first business entity in the memory element, the history including a plurality of offers included in previous transactions between the customer and the first business entity; step 232 determine, using the processor, optimization of revenue or profitability for the first business entity resulting from the plurality of offers included in the previous transactions between the customer and the first business entity; and step 234 generates, using the processor and the determination of optimization, the first offer. In another embodiment, determining optimization includes using the AIP or generating the first offer includes using the AIP.

In one embodiment, step 236 receives, using the interface element, at least one rule from a wireless communications device (WCD) or from a general-purpose computer associated with a second business entity; and step 238 stores the at least one rule in the memory element. Receiving the data regarding a current transaction includes receiving according to the at least one rule; determining the compliance of the current transaction with the at least one compliance parameter includes determining according to the at least one rule; augmenting the incentive included in the first offer includes augmenting according to the at least one rule; or generating the second offer includes generating according to the at least one rule.

In one embodiment, a WCD is usable to present the offer to the customer and step 240 stores at least one rule in a memory element for the WCD; and step 242 executes, using a processor in the WCD, the second offer according to the at least one rule.

FIG. 3 is a flow chart illustrating a present invention computer-based method for managing a progressive incentive. Although the method in FIG. 3 below is depicted as a sequence of numbered steps for clarity, no order should be inferred from the numbering unless explicitly stated. The method starts at Step 300. Step 302 stores, in a memory element for at least one specially-programmed general purpose computer, a history of transactions between a customer and a first business entity, the history including a plurality of offers included in previous transactions between the customer and the first business entity; step 304 receives, using an interface element for the at least one specially-programmed general purpose computer, data regarding a current transaction between the customer and the first business entity; step 306 determine, using a processor for the at least one specially-programmed general purpose computer, optimization of revenue or profitability for the first business entity resulting from the plurality of offers included in the previous transactions between the customer and the first business entity; step 308 modifies, using the processor and an artificial intelligence program (AIP) stored in a memory element for the at least one specially-programmed general purpose computer, an incentive included in a first offer previously presented to the customer, according to the determination of optimization of revenue or profitability; step 310 generates, using the processor, a second offer including the modified incentive; and step 312 transmits, using the interface element, the second offer for presentation to the customer.

In one embodiment, generating the second offer includes generating the second offer according to according to the determination of optimization of revenue or profitability, determining optimization includes using the AIP, generating the second offer includes using the AIP, or the second offer includes a good or service offered by the first business entity and generating the second offer includes selecting the good or service using the processor and the AIP.

In one embodiment, step 314 stores at least one compliance parameter in the memory unit; step 316 determine, using the processor and the data, compliance of the current transaction with at least one compliance parameter; and for compliance of the current transaction with the at least one compliance parameter, step 318 modifies the incentive includes augmenting the incentive. In another embodiment, determining compliance of the current transaction with the at least one compliance parameter includes using the AIP.

In one embodiment, step 320 stores at least one metric in the memory element; step 322 compares, using the processor, the data regarding the current transaction to the at least one metric stored in the memory element; and step 324 determine, using the processor and the comparison of the data regarding the current transaction to the at least one metric, a classification of the customer. Modifying the incentive included in a first offer includes using the classification of the customer, or generating the second offer includes using the classification of the customer. In another embodiment, step 326 adds the second offer to the history of transactions.

In one embodiment, step 328 generates, using the processor and the determination of optimization, the first offer. In another embodiment, step 330 generates or modifies, using the processor and the AIP, a format or temporal parameter for a presentation for the second offer, and transmitting the second offer for presentation to the customer includes transmitting the format or temporal parameter.

In one embodiment, step 332 receives, using the interface element, at least one rule from a wireless communications device (WCD) or from a general-purpose computer associated with a second business entity; step 334 stores the at least one rule in the memory element; and receiving the data regarding a current transaction includes receiving according to the at least one rule; determining the optimization includes determining according to the at least one rule; modifying the incentive included in the first offer includes modifying according to the at least one rule; or generating the second offer includes generating according to the at least one rule.

In one embodiment, a WCD is usable to present the offer to the customer and step 336 stores at least one rule in a memory element for the WCD; and step 338 executes, using a processor in the WCD, the second offer according to the at least one rule.

The following should be viewed in light of FIGS. 1 through 3. In one embodiment, for any or all of those instances of a present invention system or method in which an artificial intelligence program or generic algorithm is used, a rule or set of rules (not shown) is used in conjunction with the artificial intelligence program or generic algorithm. For example, in one embodiment, the processor in FIG. 1 uses the AIP and a rule or set of rules (not shown) stored in the memory element to generate or modify the incentive. The operation of an artificial intelligence program or generic algorithm with a rule or set of rules is described in commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007.

The present invention leverages existing or future marketing systems, marketing programs, loyalty programs, sponsor programs, coupon programs, discount systems, incentive programs, or other loyalty, marketing, or other similar systems, collectively, “marketing systems” by adding programming logic, self-learning, and self-adaptation to determine an incentive or offer, with respect to a progressive incentive program, for motivating a desired behavior by a customer. The present invention can use any, all, or none of the following considerations as part of generating, modifying, or presenting an offer or an incentive, for example, by adding programming logic, self-learning, and self-adaptation as noted supra:
1. One or more business, customer or sponsor objectives, for example, metric 138.
2. Temporal parameters, such as, time of day, day of week, month, or year.
3. Any one or more data or variables available or accessible, including, for example, any customer, business or sponsor information, such as, membership in a loyalty or other marketing program, ordering preferences or history, current sales volumes or budgets or targets, current or planned local, regional or national marketing programs or objectives, device preferences, current speed of service, quality of service or other operating data, budgets, objectives or trends, etc.

In one embodiment, the present invention employs any, all, or none of the following considerations as part of generating, modifying, or presenting an offer or an incentive, for example, by adding programming logic, self-learning, and self-adaptation as noted supra:
1. Location
2. Transaction Entry Device
3. Customer Information or objectives
4. Business Information or objectives
5. Sponsor Information or objectives
6. Marketing Program Type
7. Opt In Information
8. Offer Type
9. Payment method or terms or conditions of payment
10. Marketing Message Contents
11. Marketing Offer Objectives
12. Expected or Actual System Results or tracking data
13. System determined discounts or other incentives required to achieve desired results
14. One or more table entries provided by one or more end users, for example, a system administrator
15. One or more rules provided by one or more end users, for example, a system administrator
16. One or more genetic algorithms or other Al based rules or determination methods
17. Any other information, data, rules, system settings, or otherwise available to the marketing system or disclosed invention or the POS system or other system designed to deliver one or more marketing messages, offers, or coupons, etc.
18. Any combination or priority ranking of any two or more of the foregoing

In one embodiment, marketing messages, content, offers, incentives, or incentives, or other parameters, are created or maintained centrally or in a distributed network, including, for example, locally. Such management may be accomplished via any applicable means available, including, for example, making use of existing, e.g., off the shelf or customized tools that provide for such creating, management or distribution.

In another embodiment, in an effort to further enhance generating, modifying, or presenting an offer or an incentive, or to otherwise improve one or more aspects of the present invention, the invention may access certain information from existing systems, including, for example, existing POS databases, such as customer transaction data, price lists, inventory information or other in or above store, for example, location data, including, but not limited to data in a POS, back office system, inventory system, revenue management system, loyalty or marketing program databases, labor management or scheduling systems, time clock data, production or other management systems, for example, kitchen production or manufacturing systems, advertising creation or tracking databases, including click through data, impressions information, results data, corporate or store or location financial information, including, for example, profit and loss information, inventory data, performance metrics, for example, speed of service data, customer survey information, digital signage information or data, or any other available information or data, or system settings data.

In one embodiment, each location associated with the present invention establishes its own rules, uses its own AIP or generic algorithm, or learns from local customer behavior or other available information. In another embodiment, the present invention shares some or all available information or results data among any two or more or all locations or locations that fall within a given area, region, geography, type, or other factors, such as menu pricing, customer demographics, etc., and makes use of such information to improve the present invention's ability to generate, modify, or present an offer or an incentive. For example, when using an AI based system, such as disclosed in commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007,” one location may discover or otherwise determine that a certain type or class of incentive or presentation is particularly effective. By sharing such information among other locations, for example, similar locations, the present invention can begin to make use of the same or similar incentives, offers or benefits in other generally similar locations or with similar customers or classifications of customers so as to improve the performance of one or more other such locations or all locations. In this fashion, the present invention can learn which incentives and presentation of incentives more quickly or generally achieve the desired results or improve trends towards such results. Likewise, the present invention can more quickly determine which incentives or presentations do not yield the desired results or determine how long such offers, incentives or benefits are required to achieve the desired results.

In a further embodiment, incentives are provided or subsidized by one or more third parties, including, for example, third party sponsors. For example, a vendor supplying an item in an upsell offer could subsidize an incentive to encourage acceptance of the item. In another example, such an offer may be partially or fully subsidized by an unrelated third party sponsor. For example, as part of an upsell, a telecommunications company offers to view an advertisement for telecommunications company or fill out a survey or perform some other action or accept a subsequent or related optional or required offer, etc.

The following is a listing of exemplary hardware and software that can be used in a present invention method or system. It should be understood that a present invention method or system is not limited to any or all of the hardware or software shown and that other hardware and software are included in the spirit and scope of the claimed invention.

1. Hardware:

Central Controller or Local Controllers. The present invention can be managed by a central system on behalf of multiple business entities or locations or systems associated with portions of the multiple business entities or locations can implement the present invention.

Retailer System 1-n

Point of Sale Device 1-n

2. Software:

Incentive/Offer Program: generates offers and incentives; modifies offers and incentives, for example, based on performance metrics; generates and modifies presentations for offers and incentives; and manages offers and incentives.

The following is a listing of exemplary data bases that can be used in a present invention method or system. It should be understood that a present invention method or system is not limited to any or all of the databases shown and that other databases are included in the spirit and scope of the claimed invention.

Central System

Customer Database-stores customer information

Offer and Incentive Database-stores available offers and incentives

Offer and Incentive Rules Database-stores rules for making offers and incentives

Active Offers and Incentives Database-stores offers and incentives that are active

Transaction Database-stores transactions, including offer and incentive data

Customer Class Database-stores classes of customers

Customer Rules Database-stores rules for making offers, for example, including incentives, to customers

Customer Class Rules Database-stores rules for assigning a customer to a class

Customer Rating Database-stores a rating of each customer that qualifies the customer for offers or incentives

It is to be understood that the embodiments and variations shown and described herein are merely illustrative of the principles of this invention and that various modifications may be implemented by those skilled in the art without departing from the scope and the spirit of the invention. For example, while the invention has been illustrated as being implemented using particular computer systems including hardware components such as a computer, POS terminals, portable employee terminals, and input and output devices, the invention could also be implemented using other hardware components and/or other interconnections between such components. Also, while the invention has been described as being implemented using a computer, some or all of the functionality could alternatively reside in a POS terminal or other computing device (e.g., a headset). The invention could also be implemented using discrete hardwired components instead of computers. Further, while the above description refers to particular databases, other databases or data structures could be used. In addition, while various embodiments of methods in accordance with the invention have been discussed which include specific steps listed in specific orders, a person of skill in the art will recognize that these steps can be performed in different combinations and orders. While other modifications will be evident to those skilled in the art, the present invention is intended to extend to those modifications that nevertheless fall within the scope of the appended claims.

Thus, it is seen that the objects of the invention are efficiently obtained, although changes and modifications to the invention should be readily apparent to those having ordinary skill in the art, without departing from the spirit or scope of the invention as claimed. Although the invention is described by reference to a specific preferred embodiment, it is clear that variations can be made without departing from the scope or spirit of the invention as claimed.

What is claimed is:

1. A method for managing a progressive incentive, comprising:
receiving, using an interface element for at least one specially-programmed general purpose computer, data regarding a current transaction between a customer and a first business entity;
storing at least one compliance parameter in a memory element for the at least one specially-programmed general purpose computer;
determining, using a processor in the at least one specially-programmed general purpose computer and the data, compliance of the current transaction with at least one compliance parameter;
for compliance of the current transaction with the at least one compliance parameter, augmenting, using the processor and an artificial intelligence program (AIP) stored in the memory element, an incentive included in a first offer previously presented to the customer, the augmented incentive to optimize revenue for the first business entity or profitability of the first business entity;
generating, using the processor, a second offer including the augmented incentive; and,
transmitting, using the interface element, the second offer for presentation to the customer.

2. The method of claim 1 wherein determining compliance of the current transaction with the at least one compliance parameter includes using the AIP, or wherein the second offer includes a good or service offered by the first business entity and generating the second offer includes selecting the good or service using the processor and the AIP.

3. The method of claim 1 further comprising:
storing a history of transactions between the customer and the first business entity in the memory element, the history including a plurality of offers included in previous transactions between the customer and the first business entity; and,
determining, using the processor, optimization of revenue or profitability for the first business entity resulting from the plurality of offers included in the previous transactions between the customer and the first business entity; and,
wherein augmenting the incentive included in the first offer includes augmenting the incentive according to the determination of optimization of revenue or profitability, or wherein generating the second offer includes generating the second offer according to the determination of optimization of revenue or profitability.

4. The method of claim 3 wherein determining optimization of revenue or profitability for the first business entity includes using the AIP.

5. The method of claim 1 further comprising:
storing at least one metric in the memory element;
comparing, using the processor, the data regarding the current transaction to the at least one metric stored in the memory element; and,
determining, using the processor and the comparison of the data regarding the current transaction to the at least one metric, a classification of the customer; and,
wherein augmenting the incentive included in a first offer includes using the classification of the customer, or wherein generating the second offer includes using the classification of the customer.

6. The method of claim 5 wherein determining a classification includes using the AIP.

7. The method of claim 1 further comprising generating or modifying, using the processor and the AIP, a format or temporal parameter for a presentation for the second offer, and wherein transmitting the second offer for presentation to the customer includes transmitting the format or temporal parameter.

8. The method of claim 1 further comprising:
storing a history of transactions between the customer and the first business entity in the memory element, the history including a plurality of offers included in previous transactions between the customer and the first business entity; and,
adding the second offer to the history of transactions.

9. The method of claim 1 further comprising:
storing a history of transactions between the customer and the first business entity in the memory element, the history including a plurality of offers included in previous transactions between the customer and the first business entity;
determining, using the processor, optimization of revenue or profitability for the first business entity resulting from the plurality of offers included in the previous transactions between the customer and the first business entity; and,
generating, using the processor and the determination of optimization, the first offer.

10. The method of claim 9 wherein determining optimization includes using the AIP or wherein generating the first offer includes using the AIP.

11. The method of claim 1 further comprising the steps of:
receiving, using the interface element, at least one rule from a wireless communications device (WCD) or from a general-purpose computer associated with a second business entity; and,
storing the at least one rule in the memory element; and wherein:
receiving the data regarding a current transaction includes receiving according to the at least one rule;
determining the compliance of the current transaction with the at least one compliance parameter includes determining according to the at least one rule;
augmenting the incentive included in the first offer includes augmenting according to the at least one rule; or,
generating the second offer includes generating according to the at least one rule.

12. The method of claim 1 wherein a WCD is usable to present the offer to the customer and the method further comprising:
storing at least one rule in a memory element for the WCD; and,
executing, using a processor in the WCD, the second offer according to the at least one rule.

13. A method for managing a progressive incentive, comprising:
storing, in a memory element for at least one specially-programmed general purpose computer, a history of transactions between a customer and a first business entity, the history including a plurality of offers included in previous transactions between the customer and the first business entity;
receiving, using an interface element for the at least one specially-programmed general purpose computer, data regarding a current transaction between the customer and the first business entity;
determining, using a processor for the at least one specially-programmed general purpose computer, optimization of revenue or profitability for the first business entity resulting from the plurality of offers included in the previous transactions between the customer and the first business entity;
modifying, using the processor and an artificial intelligence program (AIP) stored in a memory element for the at least one specially-programmed general purpose computer, an incentive included in a first offer previously presented to the customer, according to the determination of optimization of revenue or profitability;
generating, using the processor, a second offer including the modified incentive; and,
transmitting, using the interface element, the second offer for presentation to the customer.

14. The method of claim 13 wherein generating the second offer includes generating the second offer according to according to the determination of optimization of revenue or profitability, wherein determining optimization includes using the AIP, wherein generating the second offer includes using the AIP, or wherein the second offer includes a good or service offered by the first business entity and generating the second offer includes selecting the good or service using the processor and the AIP.

15. The method of claim 13 further comprising:
storing at least one compliance parameter in the memory unit; and,
determining, using the processor and the data, compliance of the current transaction with at least one compliance parameter, and
wherein for compliance of the current transaction with the at least one compliance parameter, modifying the incentive includes augmenting the incentive.

16. The method of claim 15 wherein determining compliance of the current transaction with the at least one compliance parameter includes using the AIP.

17. The method of claim 13 further comprising:
storing at least one metric in the memory element;
comparing, using the processor, the data regarding the current transaction to the at least one metric stored in the memory element; and,
determining, using the processor and the comparison of the data regarding the current transaction to the at least one metric, a classification of the customer; and,
wherein modifying the incentive included in a first offer includes using the classification of the customer, or wherein generating the second offer includes using the classification of the customer.

18. The method of claim 13 further comprising adding the second offer to the history of transactions.

19. The method of claim 13 further comprising generating, using the processor and the determination of optimization, the first offer.

20. The method of claim 13 further comprising generating or modifying, using the processor and the AIP, a format or temporal parameter for a presentation for the second offer, and wherein transmitting the second offer for presentation to the customer includes transmitting the format or temporal parameter.

21. The method of claim 13 further comprising the steps of:
receiving, using the interface element, at least one rule from a wireless communications device (WCD) or from a general-purpose computer associated with a second business entity; and,
storing the at least one rule in the memory element; and wherein:
receiving the data regarding a current transaction includes receiving according to the at least one rule;
determining the optimization includes determining according to the at least one rule;
modifying the incentive included in the first offer includes modifying according to the at least one rule; or,
generating the second offer includes generating according to the at least one rule.

22. The method of claim 13 wherein a WCD is usable to present the offer to the customer and the method further comprising:
storing at least one rule in a memory element for the WCD; and,
executing, using a processor in the WCD, the second offer according to the at least one rule.

23. A system for managing a progressive incentive, comprising:
an interface element for at least one specially programmed general-purpose computer for receiving data regarding a current transaction between a customer and a first business entity;
a memory unit for the at least one specially programmed general-purpose computer for storing at least one compliance parameter and an artificial intelligence program (AIP); and,
a processor for the at least one specially programmed general-purpose computer for:
determining, using the data, compliance of the current transaction with at least one compliance parameter;
for compliance of the current transaction with the at least one compliance parameter, augmenting, using the AIP, an incentive included in a first offer previously presented to the customer, the augmented incentive to optimize revenue for the first business entity or profitability of the first business entity;
generating a second offer including the augmented incentive; and,
transmitting, using the interface element, the second offer for presentation to the customer.

24. The system of claim 23 wherein determining compliance of the current transaction with the at least one compliance parameter includes using the AIP, or wherein the second offer includes a good or service offered by the first business entity and the processor is for selecting the good or service using the AIP.

25. The system of claim 23 wherein the memory element is for storing a history of transactions between the customer and the first business entity, the history including a plurality of offers included in previous transactions between the customer and the first business entity; and, wherein the processor is for:
determining optimization of revenue or profitability for the first business entity resulting from the plurality of offers included in the previous transactions between the customer and the first business entity; and,
augmenting the incentive according to the determination of optimization of revenue or profitability; or,
generating the second offer according to the determination of optimization of revenue or profitability.

26. The system of claim 23 wherein the processor is for determining optimization of revenue or profitability for the first business entity using the AIP.

27. The system of claim 23 wherein the memory element is for storing at least one metric; and the processor is for:
comparing the data regarding the current transaction to the at least one metric stored in the memory element;
determining, using the comparison of the data regarding the current transaction to the at least one metric, a classification of the customer; and,
augmenting the incentive included in a first offer using the classification of the customer; or, generating the second offer using the classification of the customer.

28. The system of claim 27 wherein the processor is for determining the classification using the AIP.

29. The system of claim 23 wherein the processor is for generating or modifying, using the AIP, a format or temporal parameter for a presentation of the second offer and wherein transmitting the second offer for presentation to the customer includes transmitting the format or temporal parameter.

30. The system of claim 23 wherein the memory element is for storing a history of transactions between the customer and the first business entity in the memory element, the history including a plurality of offers included in previous transactions between the customer and the first business entity; and, wherein the processor is for adding the second offer to the history of transactions.

31. The system of claim 23 wherein the memory element is for storing a history of transactions between the customer and the first business entity in the memory element, the history including a plurality of offers included in previous transactions between the customer and the first business entity; and wherein the processor is for:
determining optimization of revenue or profitability for the first business entity resulting from the plurality of offers included in the previous transactions between the customer and the first business entity; and,
generating, using the determination of optimization, the first offer.

32. The system of claim 23 wherein determining optimization includes using the AIP or wherein generating the first offer includes using the AIP.

33. The system of claim 23 wherein the processor is for:
receiving, using the interface element, at least one rule from a wireless communications device (WCD) or from a general-purpose computer associated with a second business entity; and,
storing the at least one rule in the memory element;
receiving the data regarding a current transaction according to the at least one rule;
determining the compliance of the current transaction with the at least one compliance parameter according to the at least one rule;
augmenting the incentive included in the first offer according to the at least one rule; or,
generating the second offer according to the at least one rule.

34. The system of claim 23 wherein a WCD with a processor and a memory element is usable to present the offer to the customer, wherein the memory element for the WCD is for storing at least one rule in a memory element for the WCD, and wherein the processor for the WCD is for executing the second offer according to the at least one rule.

35. A system for managing a progressive incentive, comprising:
an interface element for at least one specially programmed general-purpose computer for receiving, using an interface element for the at least one specially-programmed general purpose computer, data regarding a current transaction between the customer and the first business entity;
a memory unit for the at least one specially programmed general-purpose computer for storing a history of transactions between a customer and a first business entity and for storing and an artificial intelligence program (AIP), the history including a plurality of offers included in previous transactions between the customer and the first business entity; and,
a processor for the at least one specially programmed general-purpose computer for:
determining optimization of revenue or profitability for the first business entity resulting from the plurality of offers included in the previous transactions between the customer and the first business entity;
modifying, using the AIP, an incentive included in a first offer previously presented to the customer, according to the determination of optimization of revenue or profitability;
generating a second offer including the modified incentive; and,
transmitting, using the interface element, the second offer for presentation to the customer.

36. The system of claim 35 wherein the processor is for:
generating the second offer according to the determination of optimization of revenue or profitability;
determining optimization using the AIP; or,
generating the second offer using the AIP; or,
wherein the second offer includes a good or service offered by the first business entity and the processor is for selecting the good or service using the AIP.

37. The system of claim 35 wherein the memory element is for storing at least one compliance parameter; and wherein the processor is for determining, using the data, compliance of the current transaction with at least one compliance parameter, and wherein for compliance of the current transaction with the at least one compliance parameter, modifying the incentive includes augmenting the incentive.

38. The system of claim 37 wherein determining compliance of the current transaction with the at least one compliance parameter includes using the AIP.

39. The system of claim 35 wherein the memory element is for storing at least one metric in the memory element; and wherein the processor is for:
comparing the data regarding the current transaction to the at least one metric stored in the memory element;
determining, using the comparison of the data regarding the current transaction to the at least one metric, a classification of the customer; and,
wherein modifying the incentive included in a first offer includes using the classification of the customer, or wherein generating the second offer includes using the classification of the customer.

40. The system of claim 35 wherein the processor is for adding the second offer to the history of transactions.

41. The system of claim 35 wherein the processor is for generating, using the determination of optimization, the first offer.

42. The system of claim 35 wherein the processor is for generating or modifying, using the AIP, a format or temporal parameter for a presentation for the second offer, and wherein transmitting the second offer for presentation to the customer includes transmitting the format or temporal parameter.

43. The system of claim 35 wherein the processor is for:
receiving, using the interface element, at least one rule from a wireless communications device (WCD) or from a general-purpose computer associated with a second business entity;
storing the at least one rule in the memory element; and wherein:
receiving the data regarding a current transaction includes receiving according to the at least one rule;
determining the optimization includes determining according to the at least one rule;
modifying the incentive included in the first offer includes modifying according to the at least one rule; or,
generating the second offer includes generating according to the at least one rule.

44. The system of claim 35 wherein a WCD with a processor and a memory element is usable to present the offer to the customer, wherein the memory element for the WCD is for storing at least one rule in a memory element for the WCD, and wherein the processor for the WCD is for executing the second offer according to the at least one rule.
